(19) United States
(12) Patent Application Publication
(10) Pub. No.: US 2023/0016847 A1
(43) Pub. Date: Jan. 19, 2023

(54) NON-INVASIVE METHOD AND DEVICE TO MEASURE THE FLOW RATE OF A RIVER, OPEN CHANNEL OR FLUID FLOWING IN AN UNDERGROUND PIPE OR CHANNEL

(71) Applicant: Flow-Tronic S.A., Welkenraedt (BE)

(72) Inventor: Jean-Marie SEVAR, Welkenraedt (BE)

(73) Assignee: Flow-Tronic S.A., Welkenraedt (BE)

(21) Appl. No.: 17/782,757

(22) PCT Filed: Dec. 15, 2020
(86) PCT No.: PCT/EP2020/086307

§ 371 Date: Jun. 6, 2022

(30) Foreign Application Priority Data
Dec. 16, 2019 (EP) 19216692.4

(51) Int. Cl. G01P 5/26; G01F 1/002; G01F 1/663

(52) U.S. Cl. CPC G01P 5/26; G01F 1/002; G01F 1/663; G01S 13/5242

(57) ABSTRACT

A non-invasive microwave measuring device (01) is for calculating the flow rate of a fluid. The device (01) includes a non-invasive microwave fluid velocity measuring device (03) having a patch antenna or horn antenna to generate a microwave signal (14) that is transmitted at a specific elevation angle α towards the fluid surface (16) and to receive the reflected microwave signal (15) from the fluid surface (16) with a doppler shift frequency. The measuring device (03) is suspended from a drone (02) by a suspension system (04). The suspension system (04) eliminates vibration noise generated by the drone (02). At least one vibration sensor eliminates false velocity readings. At least one angle sensor compensates for Pitch, Roll and Yaw from the drone (02) that influence the fluid surface velocity measurement.

### FIELD OF THE INVENTION

The invention relates to a method and device to measure the surface velocity over the whole cross section of a river, open channel or fluid flowing in an underground pipe or channel and calculate the flow rate by computing the shape and level in order to calculate the wet area and using the continuity equation Q=V*A.

More specifically, the present invention relates to a non-invasive method and device with a microwave antenna that is flown over the river or open channel, or flowing water in an underground pipe or channel.

### BACKGROUND OF THE INVENTION

Non-invasive methods for measuring the flow velocity of water in a river or fluid in an open channel or sewer, i.e. methods wherein there is no contact between the measuring apparatus and the fluid, are becoming more and more popular. Among the techniques used to measure the fluid velocity in a non-invasive way we can find acoustic methods, optical methods, laser methods and microwave methods, the last one being the most popular.

Velocity profiling to measure the fluid velocity of a river or channel has been used for very long time. A first method consists of a velocity sensor attached to a wading rod which is moved through the cross section of a river or channel by an operator. When the water level and/or water velocity is too high to safely make the profiling by an operator, the velocity sensor can be attached to a cable crane system for rivers that is spanned across the river or channel. Those methods are very time consuming and very expensive. When the cable crane system for rivers is used, it is a stationary application that can only be used at one particular site, and can't be used when heavy floating debris are carried by the river.

More recently ADCP (Acoustic Doppler Current Profiler) have been used to measure the flow rate from rivers or open channels. ADPC's are placed on a small boat or floating device that is tethered by an operator from a bridge or by a cable crane system for rivers. Those methods have the drawbacks that they are time consuming and that they can't be used when the river or channel are carrying floating parts and devices and when the rivers and channels are flooded.

In order to overcome this problem recently non-invasive devices have been used, mainly microwave radar devices that are carried by an operator from a bridge, making a surface velocity profile. This method has the drawbacks of being time consuming and has the problem that bridge piers are creating flow disturbances both ways upstream and downstream especially when the piers are collecting floating debris carried by the river or channel.

Non-contact devices have been carried by cable crane system for rivers as well, but this method has the drawback that the stability of the cable crane system for rivers is not good enough for making accurate measurements. Additionally cable crane system for rivers remain very expensive and inflexible.

Hydrologists have been trying to use drones carrying non-contact velocity measuring devises without gathering perfect results as those velocity measuring devices were not specifically built to be carried by drones.

### SUMMARY OF THE INVENTION

The present invention aims to provide an improved non-invasive method and device to measure the flow rate of a river, open channel or fluid flowing in an underground pipe or channel when for the last one the access to the measuring site by an operator is difficult, impossible or dangerous, or simply that complicated confined space entry needs to be avoided.

A special non-invasive flow velocity device is mounted on a drone that is precisely flown over the fluid surface to be measured, gathering the velocity readings. The velocity information is associated with the shape and level measurement to calculate the wet area and by using the continuity equation Q=V *A the flow rate is calculated.

The preferred non-invasive velocity measuring device is the microwave Radar device, but it could be any other suitable non-invasive velocity measuring technology. Drones are handy to use but induce signals, noise and errors on the measurements.

The microwave measuring devices uses the Doppler shift frequency to measure the velocity of the water surface such as laser or non-contact acoustic devices. The vibrations induced by the flying drone induce frequency peaks that need to be eliminated using (an) on-board vibration sensor(s) to detect them. In order to reduce the overall vibrations induced by the flying drone which increase the overall noise level reducing the signal to noise ratio, an anti-vibration suspension device can be used. Pitch, roll and yaw of the drone influence the measurement as well, and need to be measured with an angle sensors for accurate velocity measurements. GPS and altitude measurements might be useful but are not mandatory as drones can be set-up to fly precise routes with high accuracy. A wind measuring device, preferably a non-moving part 2 or 3 axis measuring device can be used to compensate for the wind influence, but those additional measurements are useful only when the water velocity is relatively slow.

More specifically, the present invention relates to a non-invasive microwave measuring device for calculating the flow rate of a fluid, the device comprising:
a non-invasive microwave fluid velocity measuring device using a patch antenna or horn antenna to generate a microwave signal that is transmitted at a specific elevation angle α towards the fluid surface and to receive the reflected microwave signal from the fluid surface with a doppler shift frequency;
a drone to which is suspended the measuring device via a suspension system, said suspension system reducing vibration noise generated by the drone;
at least one vibration sensor to identify and eliminate falls velocity readings induced by the drone;
at least one angle sensor to compensate for Pitch, Roll and Yaw from the drone that influence the fluid surface velocity measurement and determine the final angle from the measuring device (03) towards the fluid surface (16).

According to preferred embodiments of the invention, the device is further limited by one of the following features or by a suitable combination thereof:
the non-invasive microwave fluid velocity measuring device comprises a 3D control system with three motors able to automatically reposition the non-invasive microwave measuring device in order to compensate for the Pitch, Roll and Yaw of the drone;
the non-invasive microwave fluid velocity measuring device comprises GPS and altimeter sensors;
the non-invasive microwave fluid velocity measuring device comprises an interface to capture GPS and altimeter data from the drone;
a camera and light to facilitate the pilotage especially in underground pipes and channels;
the non-invasive microwave fluid velocity measuring device comprises a recording device to record pictures or videos taken by the drone, together with fluid velocity measurements and/or GPS and altimeter datas;
the non-invasive microwave fluid velocity measuring device comprises a level or distance measuring device and/or a wind speed and direction measurement device;
the suspension device comprises at least three tubes connected to each other by roads, the tubes connecting the velocity measuring device to the drone, the velocity measuring device being attached to first end of the tubes and the drone being attached to the second end of the tubes.
the at least three tubes have different length to give an angle for the measuring device compared to the water fluid and horizontal plane of the drone, angle that is measured by the at least one angle sensor.
elastic ropes are provided in the tubes and used to suspend the measuring device, the upper end of the elastic ropes being connected to the suspension system which is attached to the drone and the lower end of the elastic ropes being attached to the measuring device, the lower end of the elastic ropes being free from the tubes and slightly longer than the tubes.
the elasticity of the elastic ropes is chosen to absorb the undesired vibrations, with vertical movements of the measuring device remaining insignificant.
the suspension device comprises a rigid upper plate connected to the drone and a rigid lower plate connected to the non-invasive measuring device, both plates are connected with silent block types dampers.

The present invention also relates to a non-invasive method for measuring velocity measurement and distribution of a fluid flowing through a pipe or channel or in a river or open channel, the method using a non-invasive microwave fluid velocity measuring device suspended to a drone and comprising at least one vibration sensor, said method comprising the steps of:
Generating microwave signals by using a patch antenna or horn antenna;
Receiving the reflected microwave signals from the flowing fluid surface;
Generating a number of discrete data expressed in amplitude as function of time from the generated microwave signals and the reflected microwave signals with Doppler frequency shifts;
Transforming the spectrum of data expressed in the temporal domain into a frequency domain via a Fourier transform to fit a first Gaussian curve;
Determining the global measured velocity (main p) and the global velocity distribution (standard deviation a) via the first Gaussian curve;
Measuring the mechanical vibrations of the drone during the steps (a) and (b) of generating and receiving signals, to determine a sequence of vibration data being measured by the vibration sensor;
Generating, from the vibration data, a number of discrete data expressed in amplitude as a function of time;
Transforming the spectrum of vibration data expressed in the temporal domain into a frequency domain via a Fourier transform to fit a second Gaussian curve;
Determining the measured vibration induced velocity (mean p) and the vibration induced velocity distribution (standard deviation a) via the second Gaussian curve;
Applying a correction to the global measured velocity and the global velocity distribution obtained in step (e) by subtracting the measured vibration induced velocity and vibration induced velocity distribution obtained in step (j) in order to eliminate the vibrations of the drone in the calculation of velocity measurement and velocity distribution of the fluid.

According to preferred embodiments of the invention, the method is further limited by one of the following steps or by a suitable combination thereof:
the fluid surface velocity is determined from the generated microwave signals and the reflected microwave signals Doppler frequency shifts and is compensated for Pitch, Roll and Yaw from the drone by taking into account the data measured by at least one angle sensor.

### BRIEF DESCRIPTION OF THE DRAWINGS

FIG. 01 describes the complete system (01) including the drone (02), suspension system (04), non-invasive velocity measuring device (03) and optional accessories (05), (06) and (07).

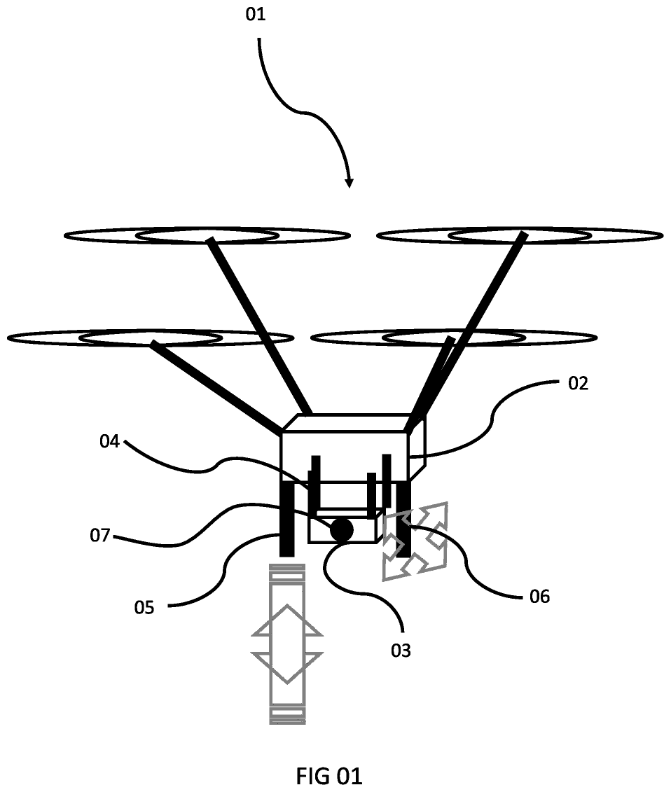

FIG. 02 describes how the non-invasive velocity measuring device (03) is attached to the drone (02) using the suspension system (04).

FIG. 03A describes in detail the suspension system (04) attaching the non-invasive velocity measuring device (03) to the drone (02).

FIG. 03 B describes an alternate suspension (04) attaching the non-invasive velocity measuring device (03) to the drone (02).

FIG. 04 describes the transmitted (14) and returned (15) microwave signal from the non-invasive measuring device (03) attached to the drone (02).

FIG. 05 describes the vibration signal (17) induced by the drone (02) and the measuring signal (18) from the reflected microwave signal.

FIG. 06 describes the Pitch, Roll and Yaw of the drone.

FIG. 07 describes the effect of the Pitch on the measured signal.

FIG. 08 describes the effect of the Yaw on the measured signal.

FIG. 09 describes a method for measuring a river or open channel surface velocity.

FIG. 10 describes the Roll effect by constant wind speed and direction on where the velocity measurement is taken.

FIG. 11 describes the Roll effect by changing wind speed and direction on where the velocity measurement is taken.

FIG. 12 describes a second method for measuring a river or open channel surface velocity.

FIG. 13 describes a measurement taken by the device (01) in an underground pipe or channel (22).

FIG. 14 describes two methods of taking the surface velocity in an underground pipe or channel (22).

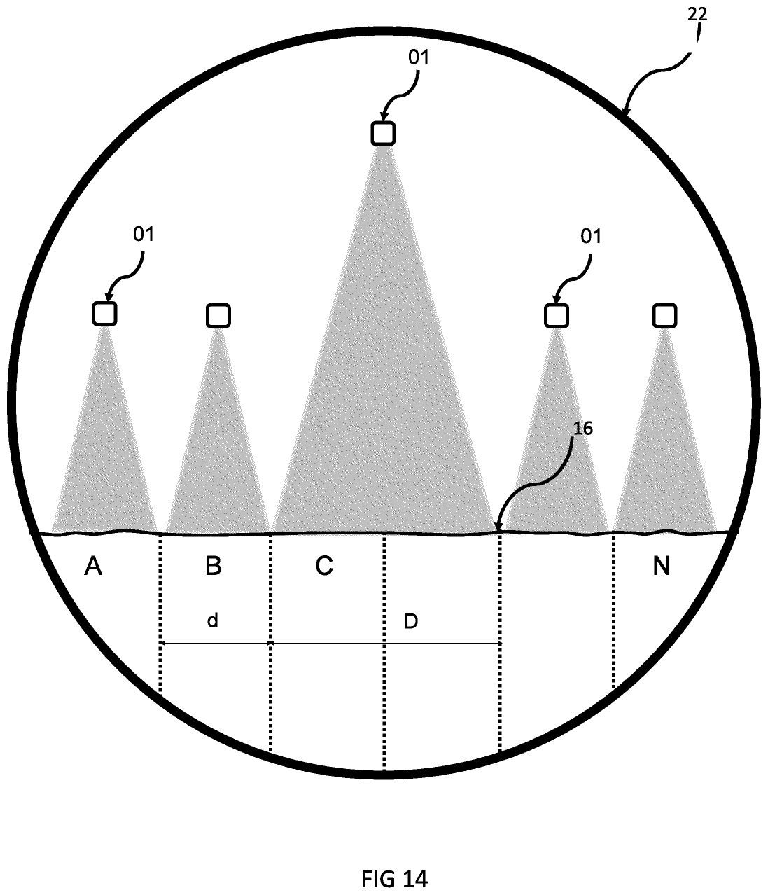

FIG. 15 describes an alternate method which consists in continuously adjusting 3D moving to the non-invasive measuring device (03), using Pitch (19), Roll (20) and Yaw (21) motors.

### DESCRIPTION OF THE INVENTION

The invention relates to a non-invasive method and device for profiling the surface velocity of a river, open channel or underground conduit that is difficult, dangerous or impossible to access by an operator. The equipment (01) comprises a drone (02) carrying a non-invasive velocity measuring device, preferably a microwave Radar device (03). This device is suspended to the drone with a suspension system (4) that drastically reduces any vibrations generated by the drone (02). The drone is piloted by an operator from the riverbank or side of an open channel or from a bridge or from distance over Internet or Satellite control or in autopilot mode. The drone can be flown far enough from piers that can induce flow disturbances. To measure the flow rate of underground conduits (22), the drone can be piloted through an inspection manhole or other access to be flown over the fluid surface to be measured.

The drone is preferably flown at a specific constant distance over the fluid surface, so that it won't be hit by floating debris carried by the fluid. The distance can be anything from close to 0.5 m to several meters depending on the application and the floating debris.

An additional distance measuring device (05) could be carried by the drone as well, but usually the accuracy of the GPS and altimeter from the drone is good enough to position the drone exactly over the fluid surface. The GPS coordinates and altitude could be gathered from the drone (02) by the measuring device (07) associated to the non-invasive velocity measuring device (03) over an appropriate communication link or could be generated by an optional GPS receiver and altimeter included in the measuring device (07) associated to the non-invasive velocity measuring device (03). Modern drones usually can fly accurately at predefined positions which can be repeated over time, avoiding handling the GPS and altimeter data. Over the appropriate communication link or over any suitable command, the device (07) can indicate to the drone (02) that the measurement of a defined spot of the fluid surface is terminated and that the drone (02) can fly to the next defined measuring spot.

Optionally a wind speed and direction device (06) can be used to validate the velocity data or correct them if necessary. Wind velocity information is usually interesting only when the water surface velocity is slow.

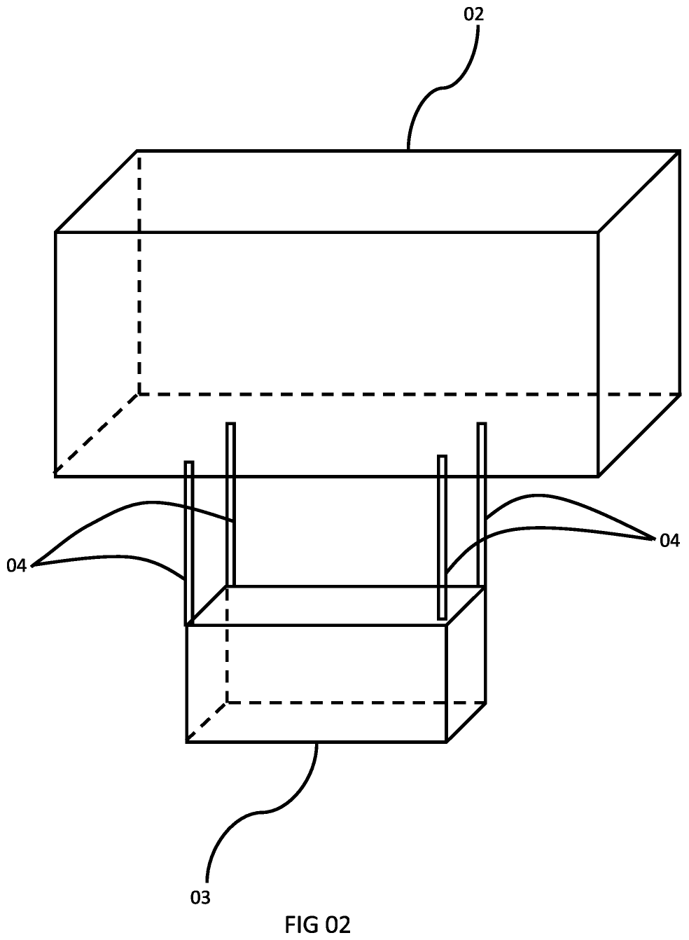

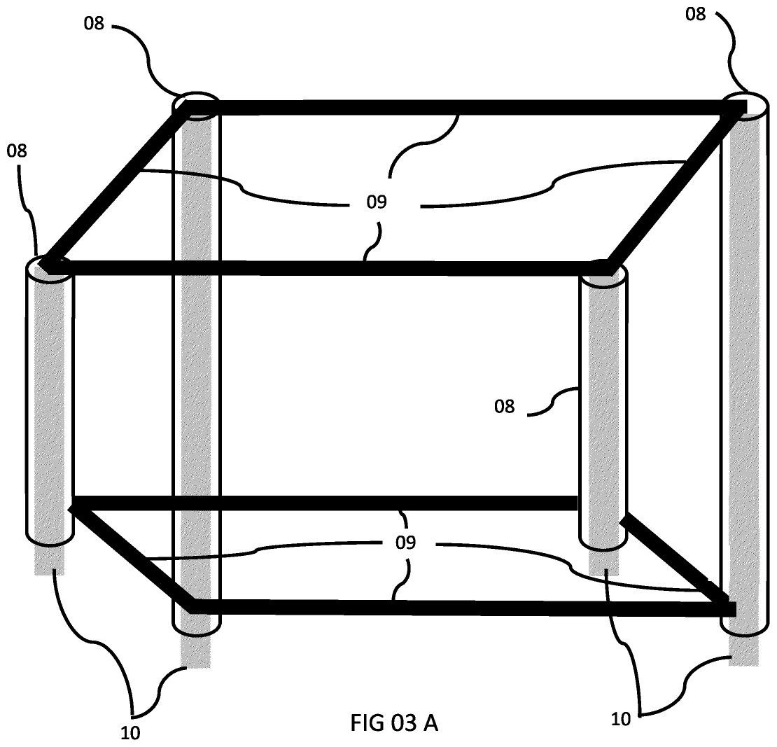

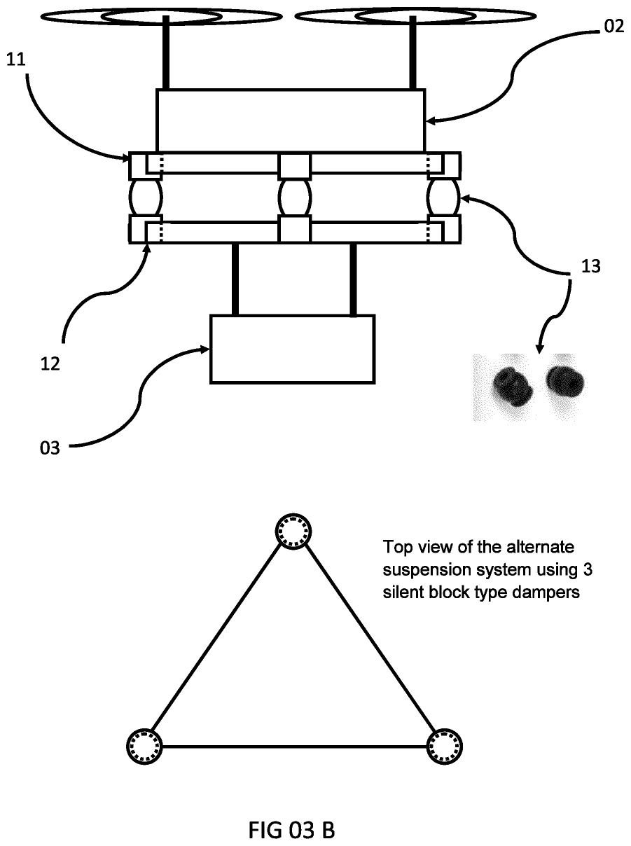

FIG. 02 shows the drone (02) with the velocity measuring device (03) with is attached to the drone using a special suspension device (04). The length of the suspension legs (08) can be of equal length as shown in FIG. 02 or can have different length as shown in FIG. 03A where the front legs are shorter than the back legs in order to automatically give an angle for the measuring device compared to the water surface and horizontal plane of the drone.

FIG. 03A shows a detailed view of the suspension system which is made out of lightweight rigid and robust tubed and rods. Usually carbon fibre tubes and rods are preferred. Three or more tubes (08) can be used. They are firmly attached using a mechanical structure made out of roads (09). Within the tubes (08) elastic ropes (10) are used in order to suspend the measuring device (03). The elastic ropes are fixed at the upper end to the suspension system which is attached to the drone (02). At the lower end the ropes (10) are free from the tubes (08) and slightly longer than the tubes. The measuring device will be attached to the elastic ropes. The elasticity of the ropes will be chosen so that the undesired vibrations are absorbed and that the vertical movements remain insignificant.

FIG. 03 B shows a detailed view of an alternate suspension system using a lightweight rigid upper plate (11) which is attached to the drone and a lower lightweight rigid plate (12) which is attached to the non-invasive measuring device (03), both plates (11) and (12) are connected with silent block types dampers (13) having the requested elasticity and suspension characteristics for the application.

It is important that the measuring device used to be carried by drones has specific additional features allowing precise measurements. Among those features angle sensors and vibration sensors are required.

Despite the elastic suspension system, mechanical vibrations can be induced by the propellers of the drone (02). Those vibrations are usually at stable frequency which can be interpreted by the measuring system as a Doppler shift frequency representing a velocity measurement that should be discarded, as explained in more details below. The water velocity spectrum is based on the microwave signal returned by the flowing water with a Doppler frequency shift proportional to the water velocity. The microwave radar system can use a horn antenna or patch or patch array antenna.

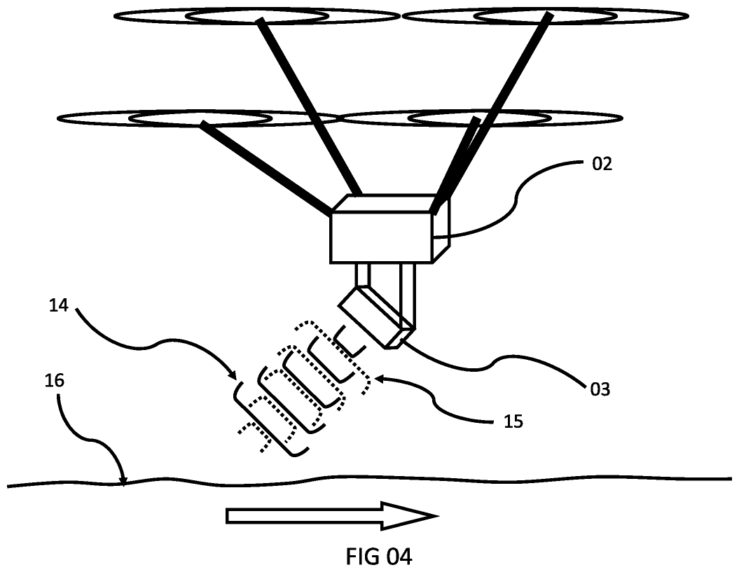

FIG. 04 shows the microwave measuring device (03) suspended to the drone (02) sending a microwave signal (14) out to the water surface (16), said water surface reflecting a return signal (15).

Preferred steps for converting a velocity spectrum into a fluid surface velocity are described in the document EP 3 011 278. They are the following. Each reflected pulse generates a measurement data. The number of reflected pulses in a sequence of measurements will generate a number of discrete data expressed in amplitude as a function of time. The spectrum of data expressed in the temporal domain is transformed into a frequency domain via a discrete Fourier transform (DFT), and preferably, a fast Fourier transform (FFT). Then a Gaussian curve is fitted on the spectrum of discrete data expressed in the frequency domain and the parameters of the Gaussian curve, namely the mean p and the standard deviation 6 respectively represent the measured velocity and the velocity distribution.

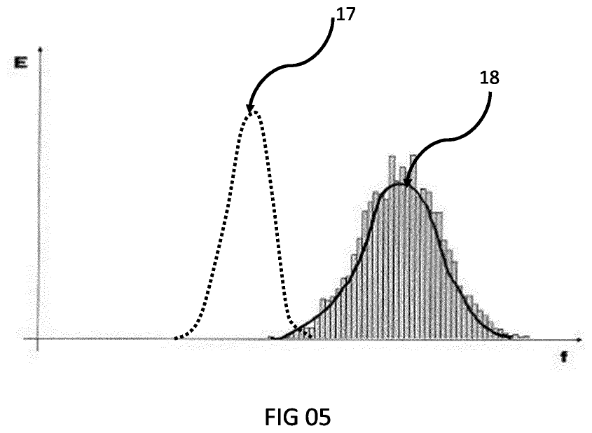

In FIG. 05, the velocity spectrum with its fitted Gaussian curve (18) is illustrated, but the signal resulting from the vibration induced by the propellers (17) is also represented. The Doppler frequency analysis cannot differentiate the signal generated by the vibration and the signal generated by the flowing fluid, both are received as velocity signals and the microprocessor cannot decide which signal to take and will jump between both signals. If the measuring device is equipped with one or more vibration sensor(s) as in the present invention, a correction can be applied to the result. Indeed, vibration sensor is able to identify and eliminate falls velocity readings induced by the drone (02) (linked to the vibration induced by the propellers). Such mechanical vibrations can be interpreted as velocity reading(s) (17) being more energetic than the real velocity measurement (18) as shown in FIG. 05. This/those sensor(s) will only detect the mechanical vibrations and only the doted Gaussian curve will appear on the analyses from the vibration sensor(s). The same signal analysis approach is taken. Each sample generates a measurement data. The number of samples in a sequence of measurements will generate a number of discrete data expressed in amplitude as a function of time. The spectrum of data expressed in the temporal domain is transformed into a frequency domain via a discrete Fourier transform (DFT), and preferably, a fast Fourier transform (FFT). Then a Gaussian curve is fitted on the spectrum of discrete data expressed in the frequency domain and the parameters of the Gaussian curve, namely the mean p and the standard deviation 6 represent the measured vibration induced velocity and the vibration induced velocity distribution. Having the sole p and 6 from the vibration signal, it can easily mathematically be removed from the combined signal (named also “global signal” in the present invention), leaving the sole fluid velocity information (18).

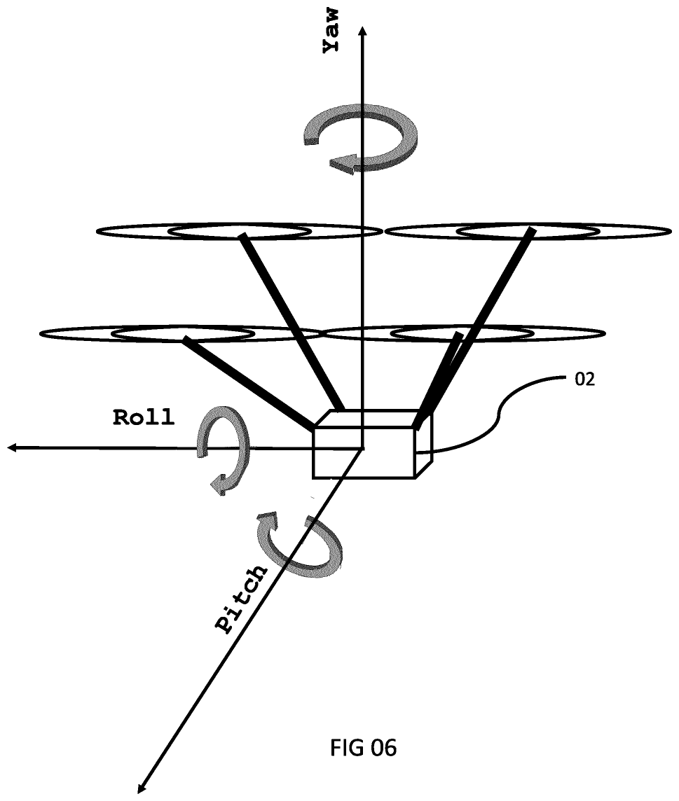

The drone is an unmanned aerial vehicle that will have its Pitch, Roll and Yaw when moving or staying over the fluid surface as shown in FIG. 06.

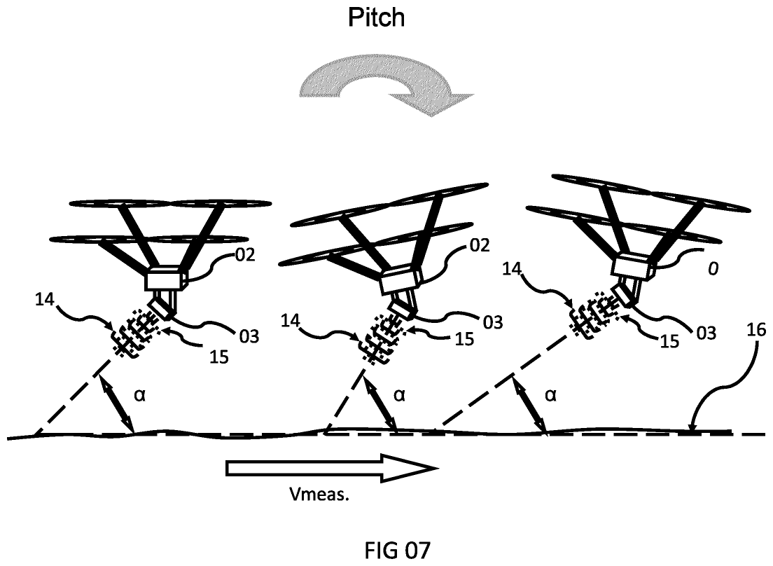

As shown in FIG. 07, the Pitch will modify the elevation angle α from the microwave measuring device suspended, and this angle α has a direct influence on the resulting calculation of the horizontal fluid velocity as the measured velocity needs to be divided by the cosine of that angle α. It is very important that a microwave measuring device carried by a drone is equipped with an adequate measuring device for the Pitch angle as it changes with wind speed and direction. The Roll and Yaw are less important as the Roll doesn't directly influence the measuring result of the fluid velocity, but only slightly shifts the position of the illuminated section of the fluid surface. The Yaw influences directly the measured fluid velocity but the Yaw angle remains usually small and the correction remains small.

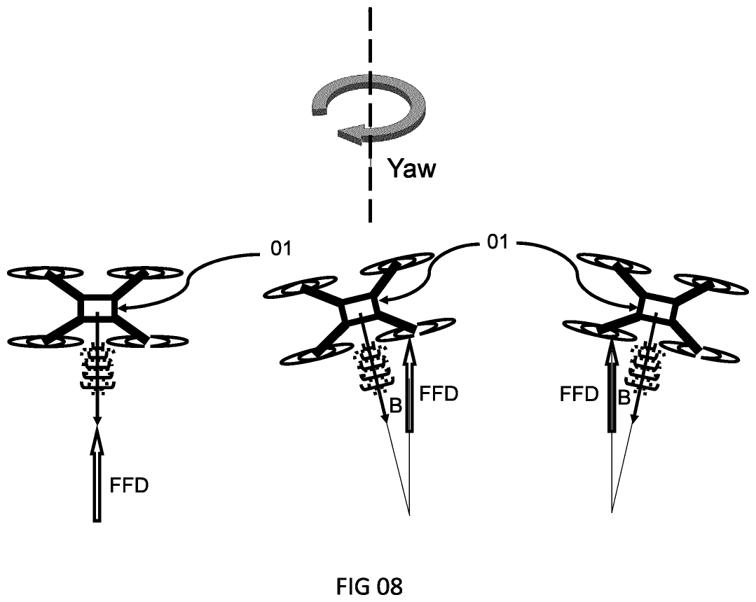

FIG. 08 shows the influence of the Yaw. When the microwave beam is not parallel with the Fluid Flow Direction FFD arrow but has an angle B, the measured velocity needs to be divided by the cosine of the Yaw angle B.

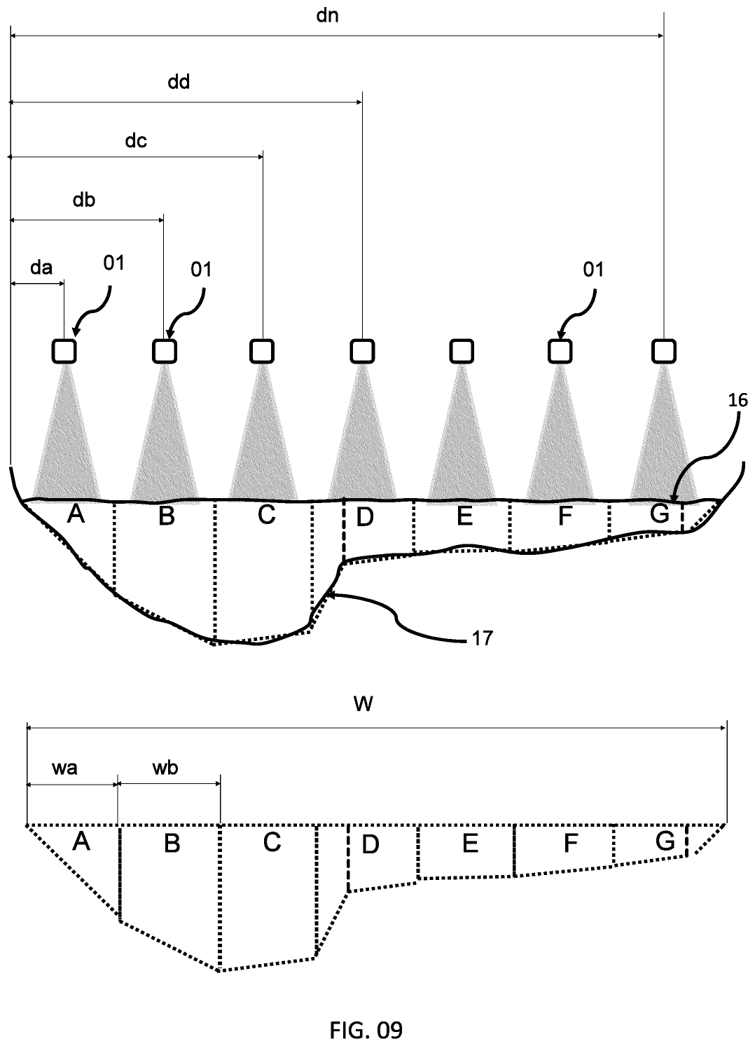

FIG. 09 shows an example of a river section that needs to be measured. The shape of the riverbed (17) has been measured and is stored in the measuring device. The water level combined to the riverbed shape allows to calculate the total width of the surface from the wetted section W, traverse distance from one riverbank to the other. This total width W is divided in a number n of sections having the same width wa, wb, . . . wn. Each area is calculated for each section A, B, C . . . N. In the example shown in FIG. 09, section A will be considered as a triangle, section B, C, E, & F will be considered as a trapeze, section D as a sum of two trapezes and section G as the sum of a trapeze and a triangle.

The device (01) (drone (02) and non-invasive microwave measuring device (03)) is piloted in the way that the microwave beam illuminates the centre part of each section A, B, C N, driving the device at distance da, db, dc . . . dn from one riverbank.

An alternate method would be to determine sections A, B, C N having the same area instead of the same width, and pilot the device (01) in the position to illuminate the centre part of each section of equal area with the microwave beam.

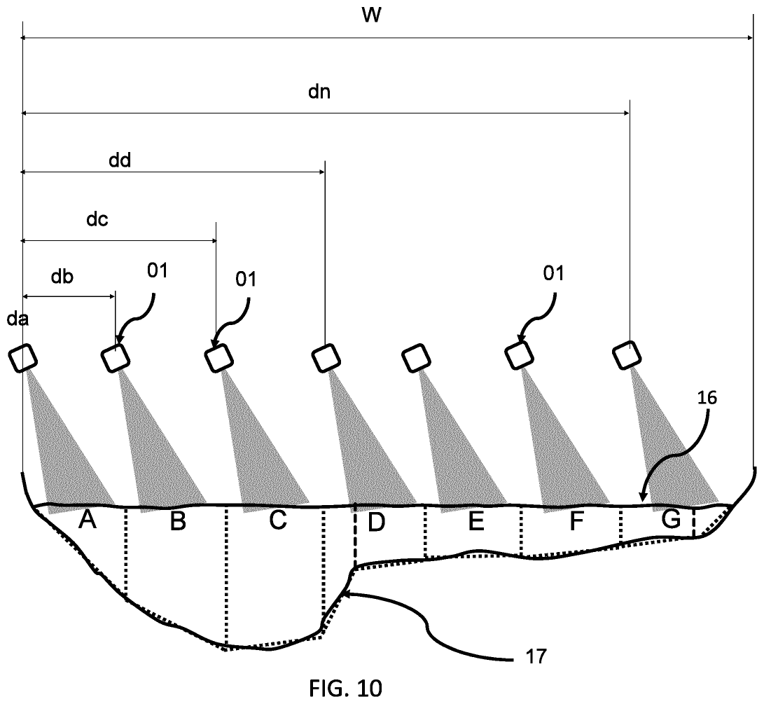

FIG. 10 shows the influence that a constant Roll angle would have on the device (01) position, (distance da, db, dc, . . . dn) to illuminate the centre part of each section with the microwave beam (constant Roll angle due to a constant wind speed and direction).

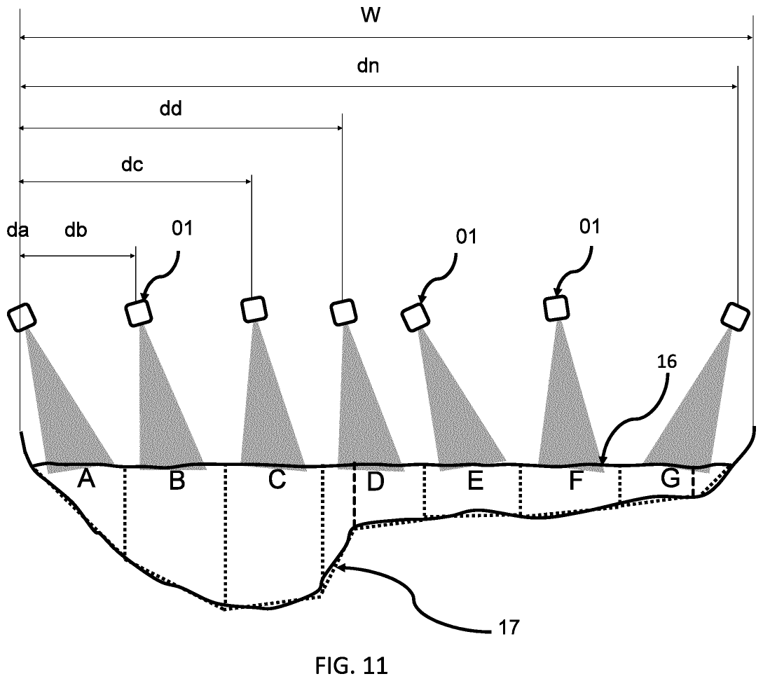

FIG. 11 shows the influence that a changing Roll angle would have on the device (01) position, (distance da, db, dc, . . . dn) to illuminate the centre part of each section with the microwave beam (changing Roll angle due to a changing wind speed and direction).

The flowrate for each section N can be calculated following the continuity equation Q_{N}=Vavg_{N}*A_{N}; were Q_{N} is the flowrate from section N, Vavg_{N} is the average velocity in the section N and A_{N} is the area from section N. The average velocity of section N, Vavg_{N} can be calculated from the measured surface velocity in the section N, Vmeas_{N} multiplied by the correction factor of section N, K_{N}.

The correction factor K_{N} from section N, is determined using the width wn of the section N, the average fluid depth in section N and a mathematical model computing those data to calculate the correction factor K_{N}.

To total river flowrate is the sum of all individual flowrates in each section: Q_{TOT}=Q_{A}+Q_{B}+Q_{C}+ . . . Q_{N}.

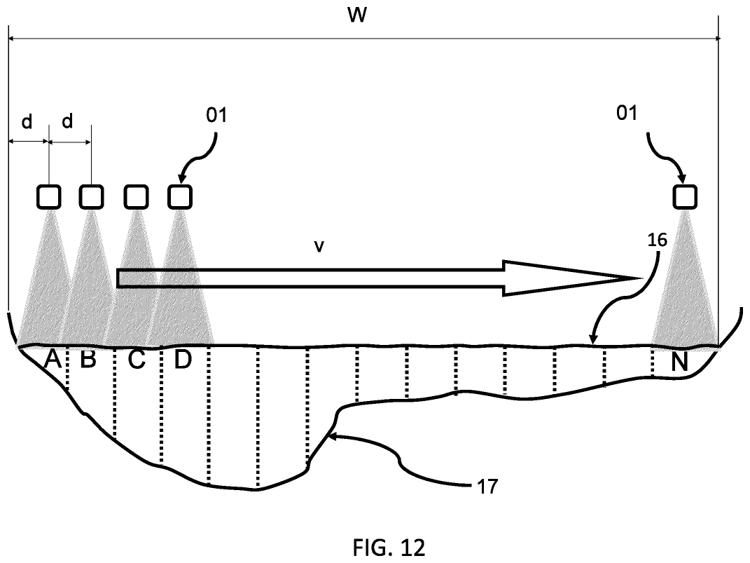

An alternate method is described in FIG. 12 and consists in moving the device (01) (drone (02) with non-invasive microwave measuring system (03)) at constant speed over the hole width W of the river from one riverbank to the other. The speed of the device (01) in meter per second divided by the time taken for a full measurement sequence gives the distance d in meter. The area under this distance d (A, B, C, . . . N) can be calculated knowing the shape of the riverbed and the water level.

The flowrate for each section N can be calculated following the continuity equation Q_{N}=Vavg_{N}*A_{N} were Q_{N} is the flowrate from section N, Vavg_{N} is the average velocity in the section N and A_{N} is the area from section N.

The average velocity of section N, Vavg_{N} can be calculated from the measured surface velocity in the section N, Vmeas._{N} multiplied by the correction factor of section N, K_{N}.

The correction factor K_{N} from section N, is determined using the width d of the section N, the average fluid depth in section N and a mathematical model computing those data to calculate the correction factor K_{N}.

The total river flowrate is the sum of all individual flowrates in each section: Q_{TOT}=Q_{A}+Q_{B}+Q_{C}+ . . . Q_{N}.

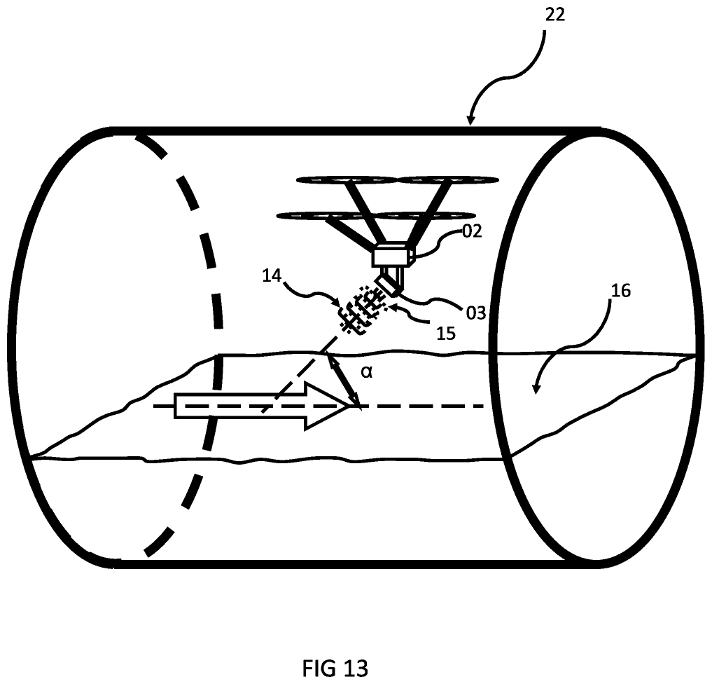

FIGS. 13 & 14 are showing the application when the device (01) (drone (02) & non-invasive microwave measuring device (03)) is used in underground channels or pipes (22). Depending on the hydraulic conditions and especially the water level, the device can be piloted to make several individual measurements in individual sections (A, B, C, N) of equal width d or take one measurement in the centre of the conduit over a width D.

If the measurement is taken over individual sections, the flowrate for each section N can be calculated following the continuity equation Q_{N}=Vavg_{N}*A_{N}; were Q_{N} is the flowrate from section N, Vavg_{N} is the average velocity in the section N and A_{N} is the area from section N.

The average velocity of section N, Vavg_{N} can be calculated from the measured surface velocity in the section N, Vmeas._{N} multiplied by the correction factor of section N, K_{N}.

The correction factor K_{N} from section N, is determined using the width d of the section N, the average fluid depth in section N and a mathematical model computing those data to calculate the correction factor K_{N}.

To total flowrate in the channel is the sum of all individual flowrates in each section: Q_{TOT}=Q_{A}+Q_{B}+Q_{C}+ . . . Q_{N}.

If only one measurement is taken in the centre of the channel, the Vmeas over the distance D is taken and multiplied by a correction factor K to determine Vavg.

The correction factor K is determined using the shape and dimension of the channel, the water depth and the velocity distribution represented by σ. A mathematical model computes those data and calculates the correction factor K. Q=Vavg.*A, where Q is the flowrate, Vavg. is the average velocity in the wetted area and A is the surface from the wetted area.

In underground channels the drone (02) will be equipped with camera and light to facilitate the pilotage.

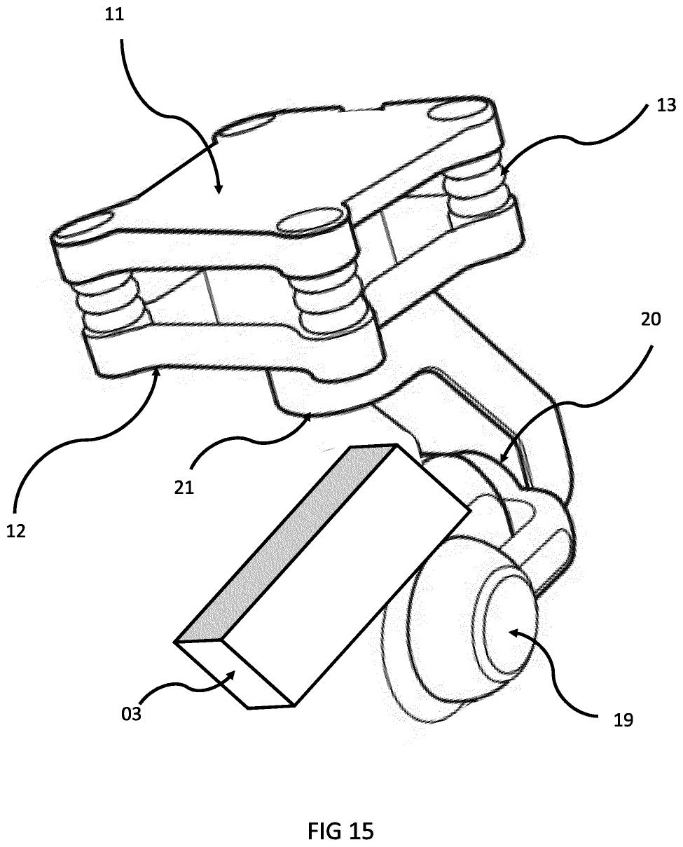

FIG. 15 describes an alternate method avoiding many corrections made on the raw measured surface velocity, which consists in continuously adjusting the 3D moves of the non-invasive measuring device (03), using 3 individual motors, the Pitch motor (19), the Roll motor (20)(20) and the Yaw motor (21), to counteract the effects of Pitch, Roll and Yaw of the drone.

1. A non-invasive microwave measuring device for calculating the flow rate of a fluid, the device comprising:
a non-invasive microwave fluid velocity measuring device comprising a patch antenna or horn antenna to generate a microwave signal that is transmitted at a specific elevation angle towards a fluid surface and to receive the microwave signal reflected from the fluid surface with a doppler shift frequency;
a drone to which is suspended the measuring device via a suspension system, said suspension system eliminating vibration noise generated by the drone;
one or more vibration sensors to identify and eliminate false velocity readings induced by the drone;
one or more angle sensors to compensate for Pitch, Roll and Yaw from the drone that influence fluid surface velocity measurement and determine a final angle from the measuring device towards the fluid surface.

2. The device according to claim 1, wherein the non-invasive microwave fluid velocity measuring device comprises a 3D control system with three motors able adapted to automatically reposition the non-invasive microwave measuring device to compensate for the Pitch, Roll and Yaw of the drone.

3. The device according to claim 1, wherein the non-invasive microwave fluid velocity measuring device is associated to a measuring device comprising GPS and altimeter sensors.

4. The device according to claim 3, wherein the non-invasive microwave fluid velocity measuring device is associated to an interface to capture GPS and altimeter data from the drone.

5. The device according to claim 1, comprising a camera and light to facilitate pilotage in underground pipes and channels (22).

6. The device according to claim 4, wherein the non-invasive microwave fluid velocity measuring device comprises a recording device to record pictures or videos, together with fluid velocity measurements and/or GPS and altimeter data.

7. The device according to claim 1, wherein the non-invasive microwave fluid velocity measuring device comprises one or more of: a level or distance measuring device, or a wind speed and direction measurement device.

8. The device according to claim 1, wherein the suspension system comprises three or more tubes connected to each other by ropes, the tubes connecting the velocity measuring device to the drone, the velocity measuring device being attached to a first end of the tubes and the drone being attached to a second end of the tubes.

9. The device according to claim 8, wherein the three or more tubes have different lengths to give an angle for the measuring device compared to the water fluid surface and horizontal plane of the drone, angle that is measured by the one or more angle sensors.

10. The device according to claim 8, wherein elastic ropes are provided in the tubes and used to suspend the measuring device, an upper end of the elastic ropes being connected to the suspension system which is attached to the drone and a lower end of the elastic ropes being attached to the measuring device, the lower end of the elastic ropes being free from the tubes and longer than the tubes.

11. The device according to claim 10, wherein elasticity of the elastic ropes is chosen to absorb undesired vibrations, with vertical movements of the measuring device remaining insignificant.

12. The device according to claim 1, wherein the suspension device comprises a rigid upper plate connected to the drone and a rigid lower plate connected to the non-invasive measuring device, both plates and are connected with silent block dampers.

13. A non-invasive method for measuring velocity measurement and distribution of a fluid flowing through a pipe or channel or in a river or open channel, the method using a non-invasive microwave fluid velocity measuring device suspended from a drone and comprising one or more vibration sensors, said method comprising the steps of:
a. generating microwave signals by using a patch antenna or horn antenna;
b. receiving microwave signals from a flowing fluid surface (16);
c. generating a plurality of discrete data expressed in amplitude as a function of time from the generated microwave signals and the reflected microwave signals with Doppler frequency shifts;
d. transforming a spectrum of data expressed in the temporal domain into a frequency domain via a Fourier transform to fit a first Gaussian curve;
e. determining global measured velocity and global velocity distribution via the first Gaussian curve;
f. measuring mechanical vibrations of the drone during the steps (a) and (b) of generating and receiving signals, to determine a sequence of vibration data being measured by the vibration sensor;
g. generating, from the vibration data, a plurality of discrete data expressed in amplitude as a function of time;
h. transforming a spectrum of vibration data expressed in the temporal domain into a frequency domain via a Fourier transform to fit a second Gaussian curve;
i. determining measured vibration induced velocity and vibration induced velocity distribution via the second Gaussian curve.
j. applying a correction to the global measured velocity and the global velocity distribution obtained in step (e) by subtracting the measured vibration induced velocity and vibration induced velocity distribution obtained in step (j) to eliminate the vibrations of the drone in calculation of real velocity measurement and real velocity distribution of the fluid.

14. The method according to claim 13, wherein the fluid surface velocity is determined from the generated microwave signals and the microwave signals with Doppler frequency shifts and is compensated for Pitch, Roll and Yaw from the drone by taking into account data measured by one or more angle sensors.
